(19) United States
(12) Patent Application Publication
(10) Pub. No.: US 2023/0070269 A1
(43) Pub. Date: Mar. 9, 2023

(54) GENERATION OF PRODUCT STRATEGY USING USER SEGMENT SEARCH TERMS

(71) Applicant: Ideoclick, Inc., Seattle, WA (US)

(72) Inventors: William Justin LEIGH, Seattle, WA (US); Thomas William FURPHY, Sammamish, WA (US); Patrick REN, Seattle, WA (US); Laura Sipiora, Seattle, WA (US)

(21) Appl. No.: 17/470,385

(22) Filed: Sep. 9, 2021

(51) Int. Cl. G06Q 10/06; G06Q 30/02

(52) U.S. Cl. CPC G06Q 10/06375; G06Q 30/0201

(57) ABSTRACT

Described herein are techniques for generating a product strategy that may be implemented by a seller to optimize a product's prominence within a product listing generated by an electronic retailer. In some embodiments, a number of user segments may be generated for a product category into which the product falls. The system then identifies a target user segment for the product from the number of user segments. Once a target user segment has been identified, revisions to product data associated with the product may be determined based upon a set of search terms associated with the target user segment. The revisions may be provided to a seller of the product via a product strategy for implementation, either as a revised product data or as a set of recommended revisions to the product data.

### BACKGROUND

Recent years have seen many consumers switch from in-person shopping to online shopping. However, sales and marketing strategies that apply to physical retail stores do not necessarily apply to electronic marketplaces. In a physical retail store, the number of products that the merchant can carry is limited by the physical size of the store. Accordingly, sales and marketing strategies must only account for a limited set of products in physical stores. However, this is not the case with online sales, in which a merchant is not limited in the number of products that can be carried. Instead, the number of products that a merchant may offer in an electronic marketplace is nearly infinite.

### SUMMARY

Techniques are provided herein for enabling optimization of product placement within an online marketplace as maintained by an electronic retailer. While the system described herein may receive certain data from the electronic retailer, the system may be unaffiliated with that electronic retailer. Hence, the system enables optimization of product placement within an online marketplace by an entity that does not have direct control over the online marketplace. To do this, the system optimizes product data with respect to a target user segment in order to improve product placement within product listings for the product within that user segment resulting in increased sales of the product. This causes a recommendation engine for the electronic retailer to be trained to present the product more prominently within product listings for a general category in the future.

In one embodiment, a method is disclosed as being performed by a service provider, the method comprising receiving product data in relation to a request to generate a product strategy for a product, determining a target user segment for the product from a number of user segments associated with a product category for the product, identifying, by the service provider, a set of search terms associated with the target user segment, generating the product strategy to include an optimization for the product data based at least in part on the set of search terms, and providing the product strategy in response to the request.

An embodiment is directed to a computing device comprising a processor; and a memory including instructions that, when executed with the processor, cause the computing device to, at least: receive product data in relation to a request to generate a product strategy for a product, determine a target user segment for the product from a number of user segments associated with a product category for the product, identify a set of search terms associated with the target user segment, generate the product strategy to include an optimization for the product data based at least in part on the set of search terms, and provide the product strategy in response to the request.

An embodiment is directed to a non-transitory computer-readable media collectively storing computer-executable instructions that upon execution cause one or more computing devices to collectively perform acts comprising: receiving product data in relation to a request to generate a product strategy for a product, determining a target user segment for the product from a number of user segments associated with a product category for the product, identifying a set of search terms associated with the target user segment, generating the product strategy to include an optimization for the product data based at least in part on the set of search terms, and providing the product strategy in response to the request.

In another embodiment, a method is disclosed as being performed by a service provider, the method comprising receiving product data in relation to a request to achieve a goal for a product, obtaining a first product listing related to the product, determining an objective position within the first product listing based at least in part on the goal, generating a product strategy based on the objective position for the product, upon determining that the product strategy has been implemented, obtaining a second product listing related to the product, determining an effectiveness value of the product strategy based upon a difference between a first position of the product within the first product listing and a second position of the product within the second product listing, and revising the product strategy based on the determined effectiveness value.

An embodiment is directed to a computing device comprising: a processor; and a memory including instructions that, when executed with the processor, cause the computing device to, at least: receive product data in relation to a request to achieve a goal for a product, obtain a first product listing related to the product, determine an objective position within the first product listing based at least in part on the goal, generate a product strategy based on the objective position for the product, upon determining that the product strategy has been implemented, obtain a second product listing related to the product, determine an effectiveness value of the product strategy based upon a difference between a first position of the product within the first product listing and a second position of the product within the second product listing, and revise the product strategy based on the determined effectiveness value.

An embodiment is directed to a non-transitory computer-readable media collectively storing computer-executable instructions that upon execution cause one or more computing devices to collectively perform acts comprising: receiving product data in relation to a request to achieve a goal for a product, obtaining a first product listing related to the product, determining an objective position within the first product listing based at least in part on the goal, generating a product strategy based on the objective position for the product, upon determining that the product strategy has been implemented, obtaining a second product listing related to the product, determining an effectiveness value of the product strategy based upon a difference between a first position of the product within the first product listing and a second position of the product within the second product listing, and revising the product strategy based on the determined effectiveness value.

Embodiments of the disclosure provide numerous advantages over conventional systems. For example, the system disclosed herein enables optimization of product placement within an online marketplace by identifying and focusing on a single user segment and by implementing high frequency search terms associated with that user segment. By optimizing product placement within a product listing directed toward a single user segment, the system can increase sales for the product with that user segment, which may then cause a recommendation engine for an electronic retailer to optimize the product's placement in product listings for a broad product category. Accordingly, the system enables a seller of a product to “train” a recommendation engine for an electronic retailer (which may employ machine learning) to optimize presentation of their product within search results without having any direct control over the recommendation engine.

Additionally, the system described herein uses novel techniques for assessing an impact of a product strategy and adjusting that product strategy automatically. For example, by assigning weighted values to each of a number of positions within a product listing, the system can estimate predicted sales for each product in those positions. The system is able to predict a change in position of a product within a product listing that is needed to achieve a goal set by a seller of the product. After implementation of the product strategy, the system is able to assess the impact of the product strategy by conducting a search in a manner similar to that of a user in order to identify the effective change in the product's position within the product listing. This enables the system to identify an effectiveness value (e.g., an elasticity) of the product strategy for a particular user segment/product category. The system can then adjust and reimplement the product strategy based on that effectiveness value. Hence, the system can automatically adapt to any given sales channel.

The foregoing, together with other features and embodiments will become more apparent upon referring to the following specification, claims, and accompanying drawings.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a computing environment that facilitates providing content recommendations for a seller in accordance with some embodiments;

FIG. 2 illustrates a block diagram showing various components of a system architecture that supports generation and implementation of a product strategy in accordance with some embodiments;

FIG. 3 illustrates a flow chart process by which a service provider generates and provides a product strategy in accordance with some embodiments;

FIG. 4 depicts an illustrative example of a process by which a feedback loop may be implemented to achieve one or more seller goals in accordance with some embodiments;

FIG. 5 depicts an illustrative example of a product data and a product strategy generated in accordance with some embodiments;

FIG. 6 depicts an example of user segment data that may be used to perform product searches to determine a state of a product in accordance with embodiments;

FIG. 7 depicts an illustrative example of a product listing that may be presented by an electronic retailer computing device in response to a broad product search in accordance with some embodiments;

FIG. 8 depicts an illustrative example of a product listing that may be presented by an electronic retailer computing device in response to a narrow product search in accordance with some embodiments;

FIG. 9 depicts a flow diagram showing an example process flow for generating and providing a product strategy in accordance with embodiments; and

FIG. 10 depicts a flow diagram showing an example process flow for implementing and adjusting a product strategy in accordance with embodiments.

### DETAILED DESCRIPTION

This disclosure is directed towards a system that facilitates optimization of product placement within product listings generated by an electronic retailer. Online marketplaces are substantially different from physical retail marketplaces in that rather than product placement being determined based on a seller purchasing a physical slot within the store for the product, the product is presented within a product listing (e.g., a set of search results) based on a determined relevance of the product to each user's search. Additionally, online retailers are not limited to just products that they can physically stock. Hence, sellers of products in online marketplaces must compete with a virtually unlimited number of competitors for a prominent placement within a product listing. However, these sellers are often not provided any insight into how relevance is determined by any particular electronic retailer.

In embodiments, the system provides techniques for generating a product strategy that may be implemented by a seller to optimize a product's prominence within a product listing generated by an electronic retailer. To do this, the system may first generate a number of user segments for a product category into which the product falls. The system then identifies one of the user segments that is relevant to the product as a target user segment. Once a target user segment has been identified, product data associated with the product may be revised using a set of search terms associated with the target user segment. For example, the system may insert, or replace current terms with, certain terms from the set of search terms into a product description. In another example, phrasing or placement of terms may be revised within the product description based on a search frequency associated with that term. By way of illustration, description dedicated to high frequency terms may be emphasized (e.g., more prominently presented, moved upward in the description, bolded, etc.) whereas description dedicated to low frequency terms may be deemphasized. Once a set of revisions has been determined, those revisions may be provided to a seller of the product as a product strategy for implementation. In some cases, the product strategy is provided as a revised product data. In other cases, the product strategy is provided as a set of recommended revisions to the product data.

Generating user segments may involve identifying a set of potential search terms that could be used by various users to perform a search for products within the category. These search terms are then compared to a set of search term frequencies (e.g., provided by an electronic retailer) in order to remove terms that are infrequently used. For example, search terms having a search frequency below a threshold frequency value may be removed from the set. The remaining set of search terms may then be assigned to a number of user segments. Note that while some search terms may be included in multiple, or all, of the user segments, each user segment will include at least one search term that is unique to that user segment, referred to as an incompatible modifier. Accordingly, each user segment may be defined by the set of search terms assigned to that user segment.

In some embodiments, the system provides techniques for determining an effectiveness value of an implemented product strategy and adjusting the product strategy to account for that determined effectiveness value. To do this, the system may identify a goal to be achieved for a product (e.g., a category share targeted by the seller). The system may determine a current status (e.g., category share) of the product within a product listing (e.g., by conducting a search on an electronic marketplace). In some embodiments, the system assigns weighted values to each position of the product listing based on sales data (e.g., received from an electronic retailer). Using the weighted values, the system may identify a minimum position to be achieved within the product listing in order to achieve the identified goal. The system then generates a product strategy (as described elsewhere) suited to achieve at least the minimum position that may include both revisions to product data as well as a marketing strategy. Once implemented, the system can then determine a new status of the product within the product listing (e.g., by conducting another search on the electronic marketplace). The new status is then compared to the previous status to determine an effectiveness value of the product strategy. In some embodiments, the product strategy is revised based on the determined effectiveness value and the revised product strategy is implemented. This process can be repeated until the goal for the product is achieved.

A category share is a percentage of a product category (i.e., a sales opportunity) a product (e.g., brand) receives (i.e., a share of total sales). It should be noted that a product category may be associated with a number of user segments, each of which are associated with a category share. Various products associated with a user segment may be associated with a category share that is a portion of the category share of the user segment. For example, a product category may include coffee makers. This product category is associated with a market represented by the total sales of all coffee makers by a particular merchant. Within this product category, a user segment may be defined by the terms “single serving drip digital coffee maker under $25.” It may be determined (e.g., based on total sales of the products falling within this user segment) that the user segment represents 30% of the total sales of coffee makers. Hence, the user segment has a category share of 30% in this example. A particular coffee maker product that falls within the user segment may make up 10% of total sales for the user segment. Hence, the product has a category share of 3% in this example.

In some embodiments, a weighted value may be assigned to a position of a product face within a product listing, such that a share of total sales for a particular product within a user segment may be determined based on that position. For example, if a user were to perform a search for a product category within an electronic marketplace, that user would be provided a product listing that includes a number of product face outs for various products matching the user's search, with each of the product face outs in the product listing being ordered based on its relevance to the search. In this example, the position of each product face out within the product listing can be mapped to a likelihood that the corresponding product will be purchased (based on historical user purchase patterns). For example, it may be determined that a product associated with a face out positioned in a first (top) position within a product listing accounts for 35% of all sales for the user segment (e.g., total sales of the product divided by total sales of the user segment). In this example, a first position of the product listing for the user segment may be assigned a weighted value of 35%. Likewise, it may be determined that a product associated with a face out positioned in a second position within a product listing accounts for 16% of all sales within the user segment. In this example, a second position of the product listing for the user segment may be assigned a weighted value of 16%. This technique may be used to determine a weighted value for each face out position for a user segment.

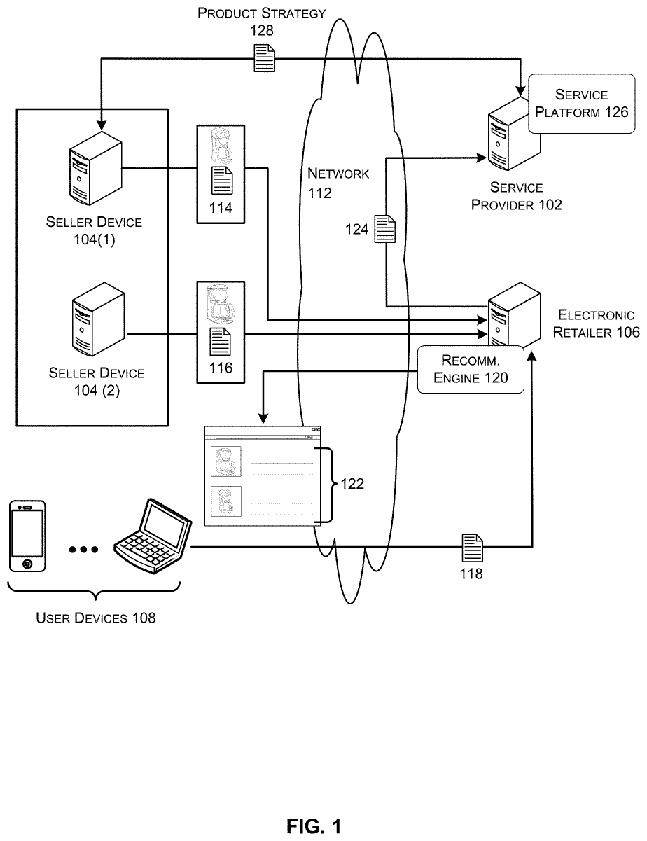

FIG. 1 illustrates a computing environment that facilitates providing content recommendations for a seller in accordance with some embodiments. The illustrated computing environment depicts interactions between a service provider 102, one or more seller computing devices 104 (1-2), an electronic retailer computing device 106, and one or more user devices 108. Each of these entities may interact via communications over a network 112.

In the computing environment 100, one or more seller computing devices 104 may provide product data (e.g., product data 114 and 116) to an electronic retailer computing device 106. Upon receiving that product data 114 and 116, product webpages may be generated based on each of the product data 114 by the electronic retailer computing device. At a subsequent time, a user may access a website (e.g., an electronic commerce site) operated by the electronic retailer computing device 106 via a user device 108. The user device may submit a search query via the accessed website to obtain information on one or more products available via an electronic marketplace maintained by the electronic retailer 106. The search query submitted to the electronic retailer computing device 106 by the user device includes a set of search terms 118. A recommendation engine 120 of the electronic retailer computing device 106, upon receiving the search query with the set of search terms 118, generates a product listing 122 that includes product data (e.g., product data 114 and 116) in the form of a product face out that is returned to the user device 108 (e.g., via the accessed website). A product face out may be any representation of information about the product. An exemplary product face out may include an image of the product, information about functionality of the product, product pricing, product availability, or any other suitable product information. The product listing 122 may comprise an ordered list of product face outs, wherein the order of the products in the list is determined by the recommendation engine 120 based at least in part on a determined relevance of the product data 114 and 116 to the set of search terms 118. In the system 100, a user may visit a webpage associated with a particular product by selecting the product face out from the product listing 122. Additionally, a user may complete a purchase of one or more products from the product listing 122.

In addition to providing product listings to a user device, the electronic retailer computing device 106 may be configured to provide search query information to third-party (e.g., unaffiliated) services, such as the service provider computing device 102. For example, the electronic retailer computing device 106 may provide a set of search terms and corresponding search frequencies 124 obtained from a number of users that have submitted search queries to the electronic retailer computing device 106. A search frequency for a term may refer to a number of times (either absolute or relative) that the term has been provided by a user within a search query.

The set of search terms and corresponding search frequencies 124 may be used by a service platform 126 operating on the service provider computing device 102 to develop a product strategy 128 in relation to a product offered by a seller. In some embodiments, the service platform 126 generates a product strategy designed to, upon implementation, cause the recommendation engine 120 to reposition a face out for a product within a product listing 122 that includes the product face out. The service platform 126, upon generating the product strategy 128, may provide the product strategy 128 to a seller device 104(1) associated with the product.

Upon receiving the product strategy 128, the seller device 104(1) may implement the product strategy 128 by adjusting the product data 114 in accordance with one or more recommendations provided via the product strategy 128. The adjusted product data 114 is then provided to the electronic retailer computing device 106 in relation to the respective product. Upon receiving a search query from a user, the recommendation engine 120 may generate a new product listing 122 in which a face out for the respective product is repositioned respective to other product face outs in the ordered list of product face outs.

In the computing environment 100, a service provider 102 may be any suitable computing device capable of performing at least a portion of the functions described herein. More particularly, a service platform 126 of the service provider 102 may be configured to receive a request from a seller device and generate a product strategy 128 for a product associated with a seller computing device 104. This process is described in greater detail below. The service platform 126 of the service provider computing device 102 may be configured to receive and consume information (e.g., a set of search terms and corresponding search frequencies 124) from an electronic retailer computing device 106.

A seller device 104 may be any suitable computing device capable of maintaining and providing product data (e.g., product data 114 or 116) to an electronic retailer computing device 106. The seller device 104 may be further configured to manage logistics on behalf of a seller entity. For example, upon receiving an indication of a product sale from the electronic retailer computing device 106, the seller computing device 104 may prepare and transmit shipping and fulfillment instructions for the product.

The electronic retailer computing device 106 may be any suitable computing device configured to maintain and operate an electronic marketplace. The electronic retailer computing device 106 may be further configured to act as a point of sale (POS) device for the seller by managing product sales on behalf of the seller. In some embodiments, the electronic retailer computing device 106 may include a recommendation engine 120 that is configured to generate a product listing based on a user search query. In some embodiments, the recommendation engine 120 may use one or more recommendation optimization algorithms. In some embodiments, a recommendation optimization algorithm may include any algorithm configured to optimize a selection of product face outs relevant to a search query as well as an order of the selected product face outs within a product listing. In some embodiments, the recommendation optimization algorithm may be adjusted based on a prediction model generated from one or more machine learning algorithms. An exemplary prediction model may be trained based on past sales conducted by the electronic retailer computing device 106.

The one or more network(s) 112 may include public networks such as the Internet, private networks such as an institutional and/or personal intranet, or some combination of private and public networks. The one or more network(s) 112 can also include any type of wired and/or wireless network, including but not limited to local area network (LANs), wide area networks (WANs), satellite networks, cable networks, Wi-Fi networks, Wi-Max networks, mobile communications networks (e.g. 3G, 4G, LTE, 5G NR-LTE, and so forth), or any combination thereof.

The service provider 102 may operate on one or more distributed computing resource(s). The one or more distributed computing resource(s) may include one or more computing device(s) that operating in a cluster or other configuration to share resources, balance load, increase performance, provide fail-over support or redundancy, or for other purposes. The one or more computing device(s) may include one or more interfaces to enable communications with other networked devices via one or more network(s).

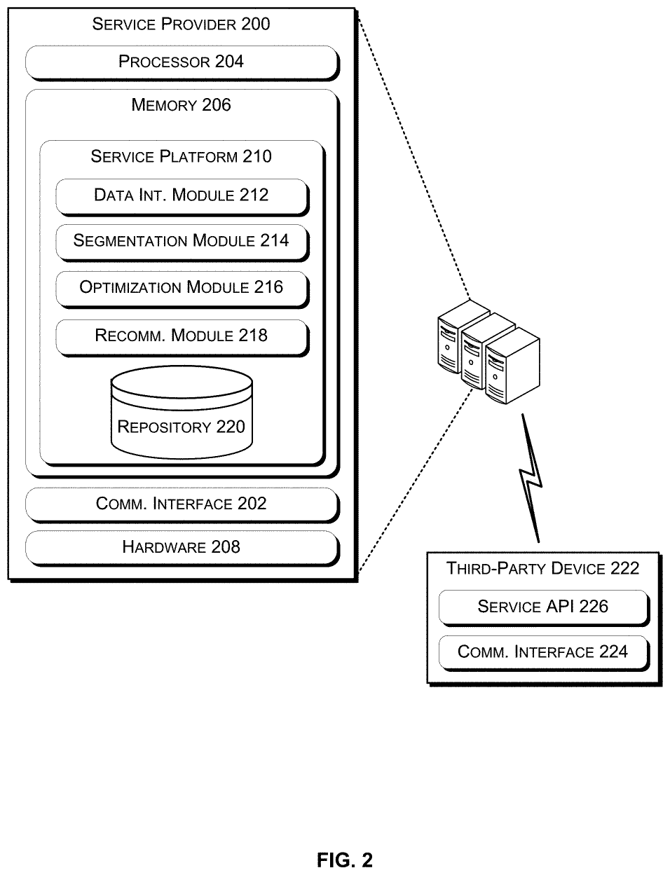

FIG. 2 illustrates a block diagram showing various components of a system architecture that supports generation and implementation of a product strategy in accordance with some embodiments. The system architecture may include one or more computing devices that make up a service provider 200. The service provider 200 may include a communication interface 202, one or more processors 204, memory 206, and hardware 208. The communication interface 202 may include wireless and/or wired communication components that enable the service provider 200 to transmit data to and receive data from other networked devices. The hardware 208 may include additional user interface, data communication, sensor, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

As described elsewhere, the service provider 200 can include any computing device configured to perform at least a portion of the operations described herein. service provider 200 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. service provider 200 can include one or more virtual machines running virtual operating systems, or other computing architectures involving virtualization such as one or more flexible pools of logical storage devices that can be virtualized to maintain virtual storage devices for the computer. For example, the service provider 200 may be virtual computing devices in the form of virtual machines or software containers that are hosted in a cloud.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the service provider 200 may include a service platform that implements functionality from or one or more software modules and data stores. Such software modules may include routines, program instructions, objects, and/or data structures that are executed by the processors 204 to perform particular tasks or implement particular data types. As depicted, the service platform 210 may include a number of different modules that each perform a portion of the functionality described herein. By way of non-limiting example, the service platform 210 may include a data interface module 212 that enables interaction between the service platform 210 and one or more third-party computing devices 222, a segmentation module 214 that generates user segments based on search terms, an optimization module 216 that determines an appropriate target user segment, and a recommendation module 218 that generates and provides a product strategy. Additionally, the service platform may include data stores (e.g., data repository 220) that include search term frequencies, product face out position statistics, customer segment information, or any other suitable information consumed in the processes described herein.

The data interface module 212 may be configured to enable communication between the service platform 210 and a third-party computing device 222. In some embodiments, the service platform 210 may maintain information regarding one or more application programming interfaces (APIs) associated with various third-party computing devices. Each of these APIs may enable communication with a respective third-party computing device. In some embodiments, upon receiving a request to communicate with a particular third-party device, the data interface module 212 may retrieve an API associated with that third-party device and format a request in accordance with a method call indicated in the API. The request may then be provided to the third-party device by the data interface module 212.

The segmentation module 214 may be configured to generate discrete logical segments of users based on search terms. A user segment is product specific and is represented by a set of search terms that users within the segment use to search for the product. User segments are discrete, in that they do not overlap. In many cases, each separate user segment may be distinguished based on certain modifiers included within the set of search terms. For example, sets of search terms for different user segments may each include a number of the same search terms but might include incompatible modifiers. By way of illustration, consider groups of users that search for coffee on an electronic marketplace. Many of the search terms (e.g., “coffee”) may be included in a search by every user that searches for coffee. However, some users may include the terms “K-CUP®,” “whole bean,” or “ground.” Each of these terms is incompatible with the others and would not likely be included within a single search. For example, a user that is searching for K-CUP® coffee likely owns a coffee maker that is unable to process whole bean or ground coffee. Accordingly, three discrete user segments can be generated in this example that are each associated with, or defined by, a different set of search terms. The different sets of search terms may each include a common set of terms as well as a respective modifier or modifiers as noted above.

The optimization module 216 may be configured to identify an opportune user segment to be targeted for a particular product. For example, upon receiving information related to a particular product, the optimization module 216 may identify a set of potential user segments to which the product may belong. In some cases, this may involve identifying a degree to which a set of search terms for a user segment overlaps with product description data received in relation to the product. A set of user segments having a degree of overlap greater than some threshold value may be identified as potential user segments for the product. The optimization module 216 may then identify a target user segment from the set of potential user segments. In some embodiments, the optimization module 216 may identify the target user segment as the potential user segment with the highest degree of overlap with the product description data. In some embodiments, the optimization module 216 may determine a currency value for each of the potential user segments in the set of potential user segments. For example, the service platform 210 may determine a currency value to be assigned to each user segments based on historical sales data associated with that user segment (e.g., via sales data received from an electronic retailer). The optimization module 216 may then identify the target user segment as the potential user segment of the set of potential user segments having the highest currency value.

The recommendation module 218 may be configured to generate a product strategy for a product based on product data received in relation to the product as well as product category data received from an electronic retailer. In some cases, the recommendation module 218 receives an indication of a total sales volume from a seller. The recommendation module 218 may convert the total sales volume to a target category share (e.g., as a percentage of the total sales for the product category) and generate a product strategy to achieve that target category share. To do this, the recommendation module 218 may determine a category share associated with a target user segment (e.g., as identified via the optimization module as described above) and a current degree of overlap of the product with the target user segment.

The recommendation module 218 may determine, based on weights associated with face out positions for a product listing associated with the user segment, a minimum face out position within the product listing that is to be obtained in order to achieve the target category share. For example, within any product listing generated for a user segment, product face outs may be associated with a weight value that represents a tendency for the corresponding product to be purchased (or at least viewed) by a user that has been provided the product listing. The service provider 200 may determine weight values for face out positions in relation to each user segment based on historical sales data and may store those weight values in a data repository 220.

The recommendation module 218 may determine a minimum face out position that may be achieved for the product by ensuring each of the search terms that define the user segment are included within the product data for the product. This may be determined based on search terms that define the user segment as well as a current position of the product face out within a product listing for the user segment. More particularly, a minimum face out position that may be achieved may be determined based upon a search frequency assigned to each search term not originally included within the product data. Note that a set of search terms and corresponding search frequencies may be provided to the service provider 200 by an electronic retailer as described in FIG. 1. By including frequently used search terms in a product description, the average position of a product face out for that product may be increased in relation to a user segment. Note that some electronic marketplace searches may only return a product facing that is associated with every search term used.

The recommendation module 218 may provide a recommendation to include one or more search terms within the product data as well as how those search terms should be incorporated. For example, the recommendation module 218 may indicate that one or more search terms should be included within the product description, whereas other search terms should be included within hidden data fields of the product data. For example, search terms that include claims that are not allowed to be made (e.g., by an electronic retailer) may be assigned to hidden data fields for the product data. In some embodiments, the recommendation module 218 may maintain information on the efficacy of positioning for various search terms within a product description. In at least some of these embodiments, the recommendation module 218 may provide a recommendation that some terms within the product description be reordered or otherwise rearranged. In some cases, a product strategy generated by the recommendation module 218 may include a revised product data to be provided to a seller.

The recommendation module 218 may be further configured to determine an advertising expenditure to be associated with the product strategy. For example, the recommendation module 218 may determine, based upon the minimum face out position that may be achieved for the product by revising the product data and a weight value associated with that minimum position, that the target category share is unlikely to be met. It should be noted that various electronic retailers may provide a service by which a seller may elect to “purchase” rights to a search term for a product for a period of time so that the seller's product is displayed more prominently when the search term is used in a search during that period of time. In embodiments, the recommendation module 218 may determine one or more search terms to be purchased with an electronic retailer in order to increase a product face out's position with respect to a user segment. In some embodiments, the search term to be purchased may include a modifier that is included in the set of search terms for the user segment that is incompatible with other user segments. In some embodiments, the search term to be purchased may be determined based on a search frequency associated with the search term. For example, a search term within a set of search terms for a user segment having the highest search frequency may be selected by the recommendation module 218. In some embodiments, multiple search terms may be determined. For example, the recommendation module 218 may select the search terms of the set of search terms for a user segment having the first, second, and third highest search frequency. In some embodiments, the recommendation module 218 may estimate a cost of performing the purchase of the one or more search terms with an electronic retailer based on information provided by the electronic retailer (e.g., pricing information).

In some embodiments, the service provider 200 may be in communication with one or more third-party devices 222. Such a third-party device 222 may be any computing device capable of interacting with the service provider 200 as described herein. Examples of third-party devices may include the electronic retailer computing device 106 and/or a seller computing device 104 as described in FIG. 1 above.

The third-party device 222 may include a processor and a computer readable memory as well as a communication interface 224. The computer readable memory of the third-party device 222 may include a service application programming interface (API) 226 that enables interaction between the third-party device 222 and the service platform 210 of the service provider 200. For example, a communication session may be established between the service provider 200 and the third-party device 222 via the respective communication interfaces 202 and 224. In some embodiments, the service API 226 may provide a user with access to functionality provided via one or more modules implemented on the service platform 210 of the service provider 200. In some embodiments, the service API 226 may be implemented on a third-party device 222 via a special-purpose software application configured to perform at least a portion of the functions described herein.

In some embodiments, the service platform 210 may require login by a user in order to access at least a portion of functionality. For example, the service platform may be accessed on a website (e.g., via a browser application) and may require a user to provide access credentials associated with a particular account maintained by the service provider in order to access information and functionality available for that account. The account may have been established between the user and the service provider 200 during an enrollment process in which the user has provided his or her personal details to the service provider as well as details relating to one or more product offerings associated with the user.

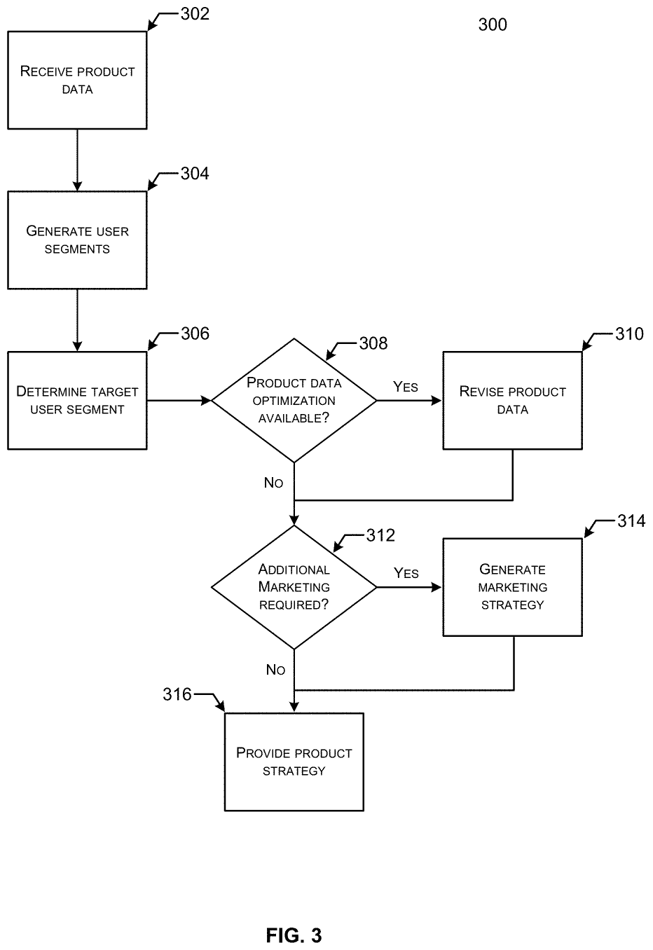

FIG. 3 illustrates a flow chart process by which a service provider generates and provides a product strategy in accordance with at least some embodiments. The process 300 involves a number of interactions between various components of the computing environment described with respect to FIG. 1. More particularly, the process 300 comprises interactions between a service provider 102, one or more seller computing devices 104, one or more electronic retailer computing devices 106, and a user device 108.

At 302, the process 300 comprises receiving product data for which to generate a product strategy. In some embodiments, the product data may be received from a seller entity via a request for a product strategy. The product data may include any number of suitable types of product information, including, but not limited to, an image of the product, a description of the product, pricing/availability of the product, measurements/performance metrics associated with the product, or any other suitable product details. In some embodiments, the product data may include one or more hidden data fields. In some embodiments, the process may further comprise receiving one or more goals in relation to the product data. For example, the service provider may receive a sales target or a target product category share to be obtained for the product.

At 304, the process 300 comprises generating user segments within a product category associated with the product. In some embodiments, this may involve identifying a number of potential search terms that may be used by users to search for products of the same type as the product. In some cases, the number of potential search terms may be provided by experts on user searches. Once a number of potential search terms have been identified as being relevant to a product category, each of those search terms may be compared against a set of search terms and corresponding search frequencies provided by an electronic retailer in order to obtain a set of product category search terms. In doing this, search terms from the set of potential search terms are compared to the set of search terms and corresponding search frequencies. Search terms from the set of potential search terms that are determined to be associated with search frequencies greater than or equal to some predetermined threshold frequency value are added to the set of product category search terms whereas search terms from the set of potential search terms that are determined to be associated with search frequencies less than the predetermined threshold frequency value are removed. Once a set of product category search terms have been identified, they may be used to generate separate sets of search terms for each of a number of user segments. In some cases, each of the generates separate sets of search terms may include at least one modifier that is incompatible with the other sets of search terms.

At 306, the process 300 comprises determining a target user segment for the product. In some embodiments, the target user segment is selected based upon a product description including a modifier that is included within a set of search terms that define the target user segment. In some embodiments, when the product may be suitable for multiple user segments, the target segment is selected based upon a total share of the product category that is associated with the target user segment. In other words, the user segment having the highest share of the product category may be selected as the target user segment for the product.

At 308, the process 300 comprises determining whether the product data can be optimized. In some embodiments, this comprises determining whether each of the search terms in the set of search terms that define the target user segment are included in a product description. Additionally, when each search term is included, determining whether the product data can be optimized may also comprise determining whether a position of various terms within a product description or a number of times that the term is used within the product description may be optimized. In some embodiments, one or more machine learning algorithms may be trained to identify an optimal position for one or more search terms within a product description.

Upon a determination being made that the product data can be optimized (e.g., yes from the decision block 308) the process may comprise generating a revised version of the product data that has been optimized at 310. Such optimization may include rearranging and/or adding search terms from the set of search terms associated with the user segment within the product description or hidden data fields of the product data. In some embodiments, optimization of the product data may be performed by one or more trained models generated using a machine learning algorithm. In some embodiments, rather than revise product data directly, the process 300 may comprise providing a recommendation to the seller for one or more changes to be made to the product data.

At 312, the process 300 comprises determining whether additional marketing will be required. In some embodiments, this may comprise determining a probable change in position of a product face out within a product listing based on implementation of revisions to be made to the product data (e.g., as provided at 310) if product optimization was performed. In these embodiments, the service provider may determine a probable product category share to be associated with the product based on the determined probable position of the product face out within the product listing. To do this, the service provider may calculate a probable product category share for the product based on a total market for the product category and a weighted value of the probable product face out position within the product listing. This is described in greater detail elsewhere. The probable product category share may then be compared to the one or more goals received in relation to the product data at 302. If the determined probable product category share is greater than or equal to a product category share indicated in the one or more goals, then a determination may be made that no additional marketing is required. Otherwise, if the determined probable product category share is less than the product category share indicated in the one or more goals, then a determination may be made that no additional marketing is required.

Upon a determination being made that additional marketing is require (e.g., yes from the decision block 312) the process may comprise generating a marketing strategy for the product at 314. In some embodiments, this may comprise identifying a subset of the set of search terms that define the target user segment and determining an expenditure to put toward a marketing campaign targeted at that subset of the search terms. For example, the search terms in the set of search terms having the highest (and second highest, third highest, etc.) search frequency may be selected for such a marketing campaign. In some embodiments, the service provider may store one or more metrics indicating an efficacy and/or cost of marketing campaigns offered by various electronic retailers. Using this stored data, the service provider may generate a marketing strategy that includes a recommendation of what services should be purchased from the electronic retailer as well as what terms should be targeted and for how long. The service provider may also determine a cost associated with achieving a particular goal with respect to the product. It should be noted that a number of electronic retailers may use a recommendation module that operates using machine learning. To that end, by maintaining a higher amount of sales for a product over some given period of time (e.g., three months), the recommendation module of the electronic retailer may be trained to position a face out for the product in a more prominent position moving forward. Accordingly, even a marketing strategy that recommends a temporary campaign may have a lasting impact on a product's face out position, generating organic sales of the product long after the marketing campaign has ceased. The process 300 may account for this impact when generating the marketing strategy.

At 316, the process 300 comprises providing a product strategy to the seller. In some embodiments, the product strategy includes both revised product data generated at 310 (or recommendations regarding revisions to be made to the product data) as well as the marketing strategy generated at 314. Upon receiving the product strategy, the seller may implement that product strategy by providing a revised product data to one or more electronic retailers as well as by implementing the marketing strategy provided. To implement the marketing strategy, the seller may contact the electronic retailer to initiate a search term campaign.

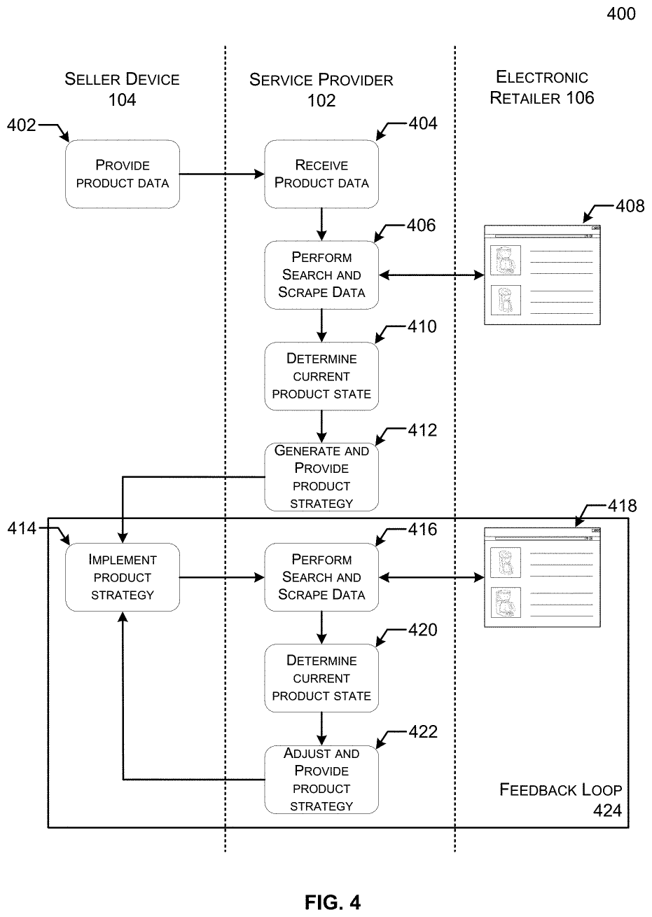

FIG. 4 depicts an illustrative example of a process by which a feedback loop may be implemented to achieve one or more seller goals in accordance with some embodiments. As illustrated, the process 400 comprises a number of interactions between various devices that include a seller device 104, a service provider 102, and an electronic retailer 106. Each of these devices are described with respect to FIG. 1 above.

At 402, the process 400 may comprise the seller device providing product data to the service provider. In some embodiments, the product data may be provided via a website operated by the service provider. In some embodiments, the seller may be associated with an account maintained by the service provider, into which the seller may be required to log in.

At 404, the process 400 may comprise the service provider receiving the product data from the seller device. Upon receiving the product data, the service provider may identify a set of search terms associated with the product. As noted elsewhere, the set of search terms may be determined based on an association with a particular user segment or user segments.

At 406, the process 400 may comprise the service provider performing a search for the product and scraping data returned in response to the search. This may comprise performing a search on an electronic marketplace hosted by the electronic retailer using the identified set of search terms. Upon performing such a search, the electronic retailer generates a product listing 408 that may include a face out associated with the product of the product data. The product listing 408 may be presented on a website operated by the electronic retailer. The service provider may then obtain (e.g., via a website scraper) information regarding content and positioning of product face outs within the product listing. In this way, the service provider may identify a number of products relevant to a search as well as the perceived (as by the electronic retailer) relevance of each product to the search based on a position of a face out for each product within the product listing.

In some embodiments, the service provider may assign a weight value to each position of the product listing. To do this, the service provider may identify a product associated with each position of the product listing based on the corresponding face out found in that position. The service provider may then determine a percentage of sales in the product category that corresponds to the product. In some embodiments, the weight value for a position in the product listing may be representative of the percentage of product category sales made up by a product for which a face out is currently occupying that position in the product listing. As noted elsewhere, this weight value may be used to generate a product strategy.

At 410 the process 400 may comprise determining a current state of the product for which the product data was received. To do this, the service provider may identify a current position of a face out associated with the product within the product listing 408. In some embodiments, the service provider may compare one or more attributes of the product with attributes of other products identified from the product listing. For example, the service provider may compare price, user rating, availability, shipping costs, or any other suitable product details. Once a current state of the product has been determined, the service provider may generate and provide a product strategy at 412. It should be noted that a process for generating and providing a product strategy is described in greater detail in FIG. 3 above.

At 414, the process 400 may comprise the seller device implementing the product strategy. To do this, the seller device may update product data stored by the electronic retailer. For example, the seller may update a product webpage maintained on an electronic marketplace hosted by the electronic retailer. Once this has been done, the seller may indicate to the service provider that the product strategy has been updated.

At 416, the process 400 may comprise the service provider, upon receiving an indication that the product strategy has been implemented, performing an additional search for the product and scraping data returned in response to the search. This may once more comprise performing a search on an electronic marketplace hosted by the electronic retailer using the identified set of search terms. Upon performing such a search, the electronic retailer generates an updated product listing 418 that may include a face out associated with the product of the product data. Once again, the product listing 418 may be presented on a website operated by the electronic retailer. The service provider may then obtain (e.g., via a website scraper) information regarding content and positioning of product face outs within the product listing.

At 420 the process 400 may comprise once more determining a current state of the product for which the product data was received. To do this, the service provider may identify a new current position of a face out associated with the product within the product listing 418. The service provider may then determine, based on the new current position and the weight values determined for each position of the product listing at 410, a predicted number of sales for the product.

In some embodiments, the predicted number of sales for the product may fall short of a goal provided by the seller at 402. Upon determining that the predicted number of sales is insufficient, the process 400 may comprise adjusting the product strategy and providing that adjusted product strategy to the seller at 422. In some embodiments, the service provider may determine an effectiveness value of the product strategy based on a change in a position of the face out for the product between product listing 408 and product listing 418. In some embodiments, adjusting the product strategy may comprise including additional search terms and/or increasing an expenditure on a marketing campaign. The amount of adjustment made to the product strategy may be made based on a determined effectiveness value of the previous product strategy.

Upon receiving the adjusted product strategy, the seller may implement that adjusted product strategy and indicate to the service provider that the adjusted product strategy has been implemented. As depicted, blocks 414 through 422 may constitute a feedback loop 424 in that they may be repeated any number of times until a predicted number of sales for the product is aligned with a goal provided by the seller.

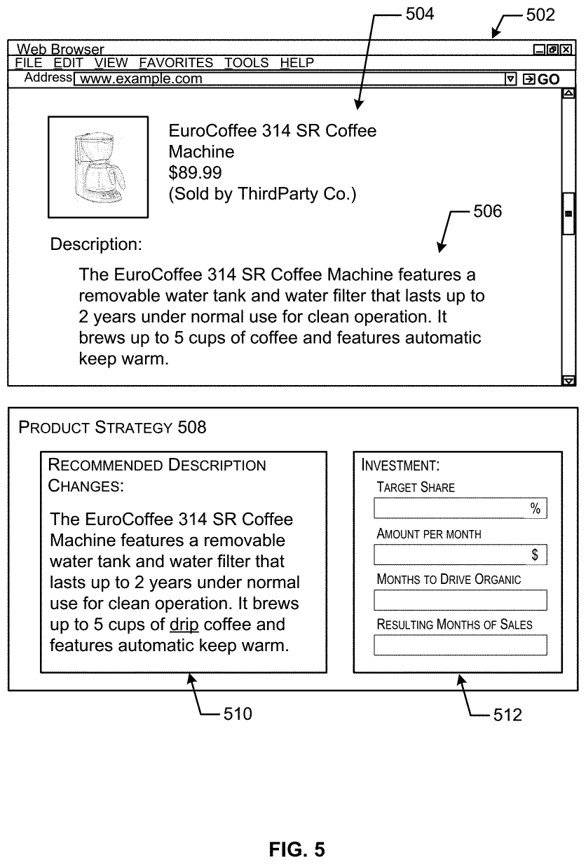

FIG. 5 depicts an illustrative example of a product data and a product strategy generated in accordance with at least some embodiments. In some embodiments, a user may provide product data to a service provider in order to obtain a product strategy. Such product data may be provided via a product page 502. The product page may include at least a product name 504 and a corresponding product description 506.

As described elsewhere (e.g., 412 of process 400), a product strategy may be generated based on information included within the product data. In some embodiments, such a product strategy may include one or more recommended changes 510 to be applied to a product description. In some embodiments, a user segment and corresponding search terms may be identified in relation to the product. For example, an indication of a user segment may be provided by a user. The recommended changes may be determined based on search terms associated with a user segment. For example, one or more edits may be proposed that would incorporate one or more search terms into the product description that are initially missing from it. In some embodiments, one or more natural language processing techniques may be used to determine an appropriate context and/or usage for the terms to be added within the product description.

In some embodiments, the product strategy may further include an indication of a proposed investment 512 to accompany the recommended changes to the description. Such a proposed investment may include an indication of a target share to be achieved for the product as well as an indication of an amount of investment is determined to be needed to achieve the target share (which may include an indication of an amount of money and time). In some embodiments, the proposed investment may indicate an amount of time that the product strategy is likely to work for. The proposed investment may be generated based on an investment (in time and money) that is determined to result in achieving a target number of organic sales of the product. For example, the proposed investment may be determined to result in a sufficient number of sales of the product by an electronic retailer that a recommendation engine is trained to present the product more prominently to consumers performing a search for a category into which the product belongs.

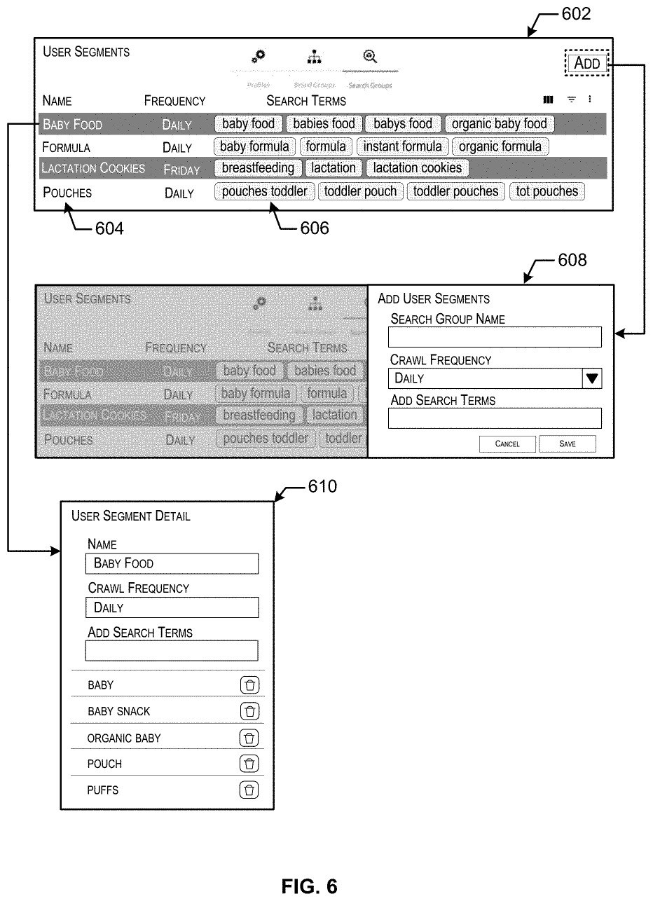

FIG. 6 depicts an example of user segment data that may be used to perform product searches to determine a state of a product in accordance with embodiments. In some embodiments, one or more elements of user segment data 602 may be presented to a user via a graphical user interface (GUI). User segment data 602 may include an indication of one or more user segments 604. Each of the user segments may include a set of search terms 606 that corresponds to that user segment. The user segment data may be used to perform a search of product data to obtain a product listing. In some cases, this may comprise performing a search with an electronic retailer on a periodic basis. Such a search may be performed using the set of search terms corresponding to each user segment.

In some embodiments, a user segment may be added to the user segment data. In some cases, a user segment may be added to the user segment data automatically. For example, one or more products may be identified with respect to sales conducted by an electronic retailer. For example, a product may be determined to be a high-selling product according to sales data provided by the electronic retailer. In some cases, search frequency data provided by the electronic retailer is used to determine a set of search terms that is frequently used to search for that product. A user segment may then be generated automatically based on the determined set of search terms.

In some cases, a user segment may be added to the user segment data manually by a user. For example, an administrator or other user may select to add a user segment to the user segment data. The user may be presented with an input interface 608 with which to provide an indication of one or more attributes and search terms to be associated with the user segment.

In some cases, a user segment may be updated or modified by a user. For example, an administrator or other user may select to update a user segment and may be presented with a modification interface 610. The user may then select and modify one or more attributes associated with the user segment via the modification interface.

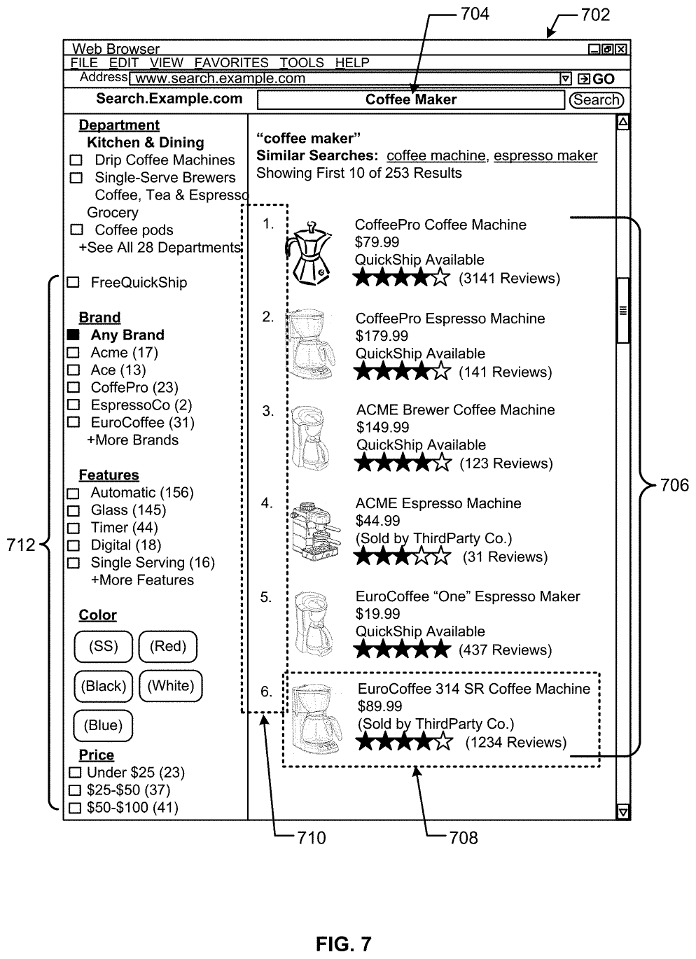

FIG. 7 depicts an illustrative example of a product listing that may be presented by an electronic retailer computing device in response to a broad product search in accordance with at least some embodiments. As noted elsewhere, communication between a user device and an electronic retailer computing device may be enabled via a website 702 (e.g., displayed via a web browser application) hosted by the electronic retailer computing device and accessed by the user device.

In some embodiments, a user may access a search webpage for the electronic retailer and may initiate a search by providing one or more search terms 704 into a text input field of the search webpage. Upon receiving the one or more search terms 704, the electronic retailer may generate and display within the webpage a product listing 706 that comprises a set of product face outs. In the current example, the one or more search terms include “coffee maker,” which may refer to a broad category of products. Accordingly, the product listing 706 may include most, if not all, products that fall within the product category.

A product face out (e.g., product face out 708) may include a number of details relating to a particular product that the product face out represents. Such details may include an image (e.g., a thumbnail or other image) of the product, a product title, a product price, seller information, user ratings for the product, or any other suitable information. The product face outs of the product listing may be presented in a specific order 710, with the product face out presented in the first position (e.g., the top of the list of face outs) being considered the product face out most relevant to the conducted search. In some cases, the product listing may be accompanied by a set of filters 712 that can be used to remove certain product face outs from the product listing.

In some embodiments, selection of a particular product face out from the product listing may cause the web browser to display a product webpage dedicated to the product represented by the face out. For example, upon selection of a product face out from the product listing, the web browser application may be redirected to a webpage hosted by the electronic retailer that includes more information about the product associated with the face out. In some embodiments, a user may be provided with the ability to add the product to a virtual shopping cart or purchase the product via that product web page.

In some embodiments, the product listing 706 may be generated by a recommendation engine (e.g., recommendation engine 120 of FIG. 1) maintained by the electronic retailer computing device. This recommendation engine may select the product face outs to be included within the product listing as well as the order in which those product face outs may be presented. To do this, some recommendation engines may use one or more machine learning algorithms to determine what products are most relevant to any given set of search terms. When determining whether to include a product face out within a product listing, the recommendation engine may assess a product description for the product as well as hidden terms associated with the product to determine a degree to which the product aligns with the search terms presented. Additionally, the recommendation engine may take into account a popularity of a particular product, by assigning a higher relevance to products that are more frequently purchased and/or rated highly. Accordingly, it should be noted that increasing sales of a particular product may cause (e.g., via training) the recommendation engine to assign a more prominent position to a product face out for that product in future product listings for the product category. Hence, it should be noted that optimizing sales for a product within a particular target user segment may also result in improvements to a position of that product's face out within a broader product listing by training the recommendation engine.

In some embodiments, a service provider as described herein may perform a search via a webpage operated by an electronic retailer in order to obtain the product listing 706. In these embodiments, the service provider may identify a current status of a particular product face out 708 based on its position within the product listing. In some embodiments, the service provider may also determine a weighted value for each position within the product listing based on a sales volume of a respective product associated with that position. Such weighted values may be determined with respect to a total sales volume for the product listing. For example, the service provider may determine that a product associated with the number one (e.g., top) position in the product listing accounted for 35% of all sales conducted for products within the product listing. In this example, the first position of the product listing may be associated with a weighted value of 35%. In some embodiments, this may be done using sales data provided by the electronic retailer. For example, the electronic retailer may provider data on how many of each product that it offers have been sold by the electronic retailer over some period of time. In this example, the service provider may determine a weighted value to be associated with each position within the product listing based on a sales amount for a product associated with a product face out in that position within the product listing.

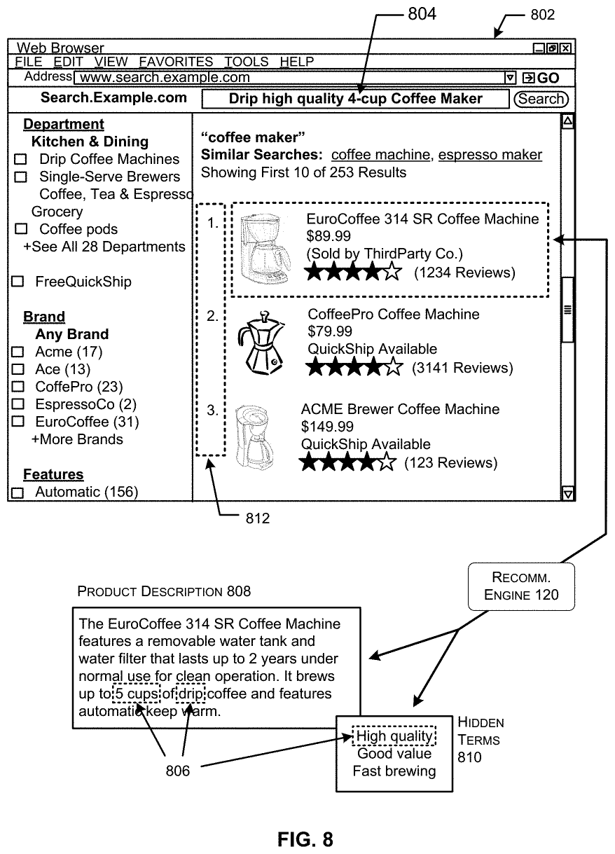

FIG. 8 depicts an illustrative example of a product listing that may be presented by an electronic retailer computing device in response to a narrow product search in accordance with at least some embodiments. Similar to the example provided in FIG. 7, communication between a user device and an electronic retailer computing device may be enabled via a website 802. In this illustrative example, a user may access a search webpage for the electronic retailer and may initiate a search by providing one or more search terms 804 into a text input field of the search webpage. In the current example, the one or more search terms include “drip high quality 4-cup coffee maker,” which may refer to a narrow grouping of products within the broad product category. Accordingly, a product listing 806 generated for the received search terms may include only face outs for a subset of the products offered by the electronic retailer within the product category. More particularly, the product face outs listed within the product listing may correspond to those associated with a particular user segment as defined by the set of search terms.

As noted elsewhere, the product listing may be generated by a recommendation engine 120 operated by an electronic retailer computing device. To do this, the recommendation engine may determine a relevancy of product data for a number of products to the provided set of search terms 804. More particularly, the recommendation engine may attempt to match each of the search terms in the set of search terms with terms in the product data. In some embodiments, the recommendation engine may match the search terms in the set of search terms to terms 806 within a product description 808 and/or a set of hidden terms 810. In some embodiments, certain search terms may be disallowed in a product description by the electronic retailer. For example, terms that are subjective or terms that represent “claims” that cannot be proven may be disallowed within the product description by an electronic retailer. In some embodiments, the recommendation engine may use one or more sentiment analysis techniques to determine a sentiment associated with the use of each search term within the product description 808. For example, the recommendation engine may determine whether each term 806 of the product data is used in a positive or negative manner (e.g., “includes X” as opposed to “does not include X”). As described elsewhere, the recommendation engine may assign a position 812 to each product face out within the generated product listing based on its determined relevance to the search.

In some embodiments, the recommendation engine may interpret certain search terms as including, or being, a minimum or maximum value. For example, when applied to coffee makers, the recommendation engine may interpret the search term “4-cup” as coffee makers that are able to make at least four cups of coffee. In this example, the recommendation engine may identify a term indicating “5 cups” as matching the search term “4-cup” for the purposes of determining product relevance to the conducted search.

In some embodiments, a recommendation engine for an electronic retailer may determine a degree to which a product is relevant to a conducted search based not only on a match between the search terms in the set of search terms 804 and terms 806 found within the product data, but also based on a strength of that match. For example, the recommendation engine may determine a prominence or importance for each term 806 based on a context in which the term is used, the number of times the term is used within the product description, the term's positioning within the product description, etc. Accordingly, a service provider configured to generate a product strategy for a particular electronic retailer may be trained to recognize these factors. In some embodiments, the service provider may employ one or more machine learning techniques to identify optimal uses of various terms within a product data. In some embodiments, this may be done by producing a product data, providing it to the electronic retailer, checking a first position of the product within a product listing upon conducting a search, revising the product data, providing the revised product data to the electronic retailer, checking a second position of the product within a product listing upon conducting another search, and comparing the first position with the second position.

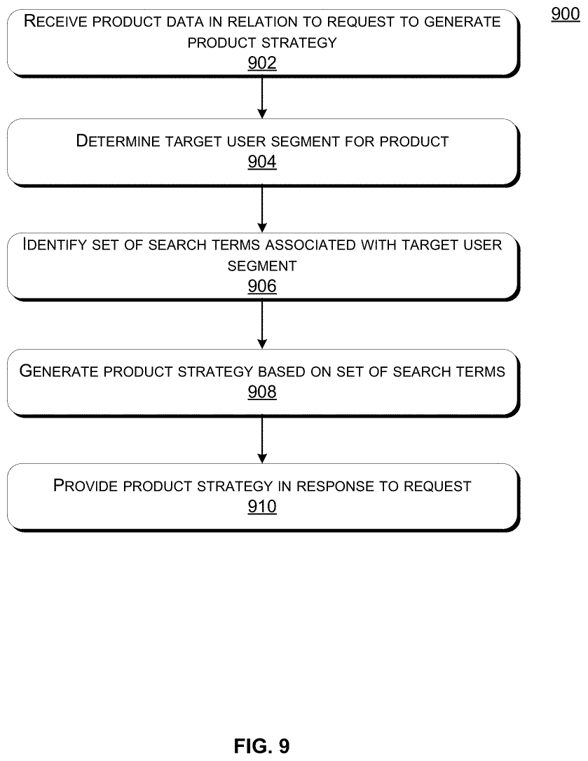

FIG. 9 depicts a flow diagram showing an example process flow 900 for generating and providing a product strategy in accordance with embodiments. The process flow 900 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. The process 900 may be performed by a computing device that is configured to generate and provide a product strategy for a product. For example, the process 900 may be performed by a service provider computing device, such as the service provider 102 described with respect to FIG. 1 above.

At 902, the process 900 comprises receiving product data for a product in relation to a request to generate a product strategy. In some embodiments, the product data is received via a website operated by the computing device. The product data may include a number of details related to a product. For example, the product data may include a product image, a product name, a price, a product description, a hidden data field, or any other suitable product details.

At 904, the process 900 comprises determining a target user segment for the product based on the provided product data. In some embodiments, each of the number of user segments associated with the product category for the product is associated with a corresponding set of search terms is generated to include high frequency search terms and at least one modifier that is incompatible with the other user segments of the number of user segments. In at least some of these embodiments, the target user segment is determined based on the at least one modifier.

At 906, the process 900 comprises identifying a set of search terms associated with the target user segment. In some embodiments, the set of search terms is determined by virtue of the set of search terms defining the target user segment.

At 908, the process 900 comprises generating a product strategy based on the set of search terms. In some embodiments, generating the product strategy comprises revising a product description within the product data to include each of the search terms in the set of search terms. In some embodiments, generating the product strategy comprises revising a position of one or more of the search terms in the set of search terms within the product data. In some embodiments, generating the product strategy comprises determining a marketing strategy related to at least one of the search terms in the set of search terms. In some cases, the process 900 may further comprise generating the product strategy further comprises determining an expenditure for the marketing strategy.

In some embodiments, generating the product strategy comprises determining an optimal placement of each of the search terms of the set of search terms within the product data. In some cases, the optimal placement for at least a portion of the search terms of the set of search terms comprises a placement within a product description of the product data. In some cases, the optimal placement for at least a portion of the search terms of the set of search terms comprises a placement within a hidden data field of the product data.

At 910, the process 900 comprises providing the generated product strategy in response to the received request. In some embodiments, the product strategy is provided as a recommended set of revisions to the product data. In some embodiments, providing the product strategy in response to the request comprises providing a recommended set of revisions to the product data. In some embodiments, providing the product strategy in response to the request comprises generating a revised product data based on the determined optimization and providing the revised product data.

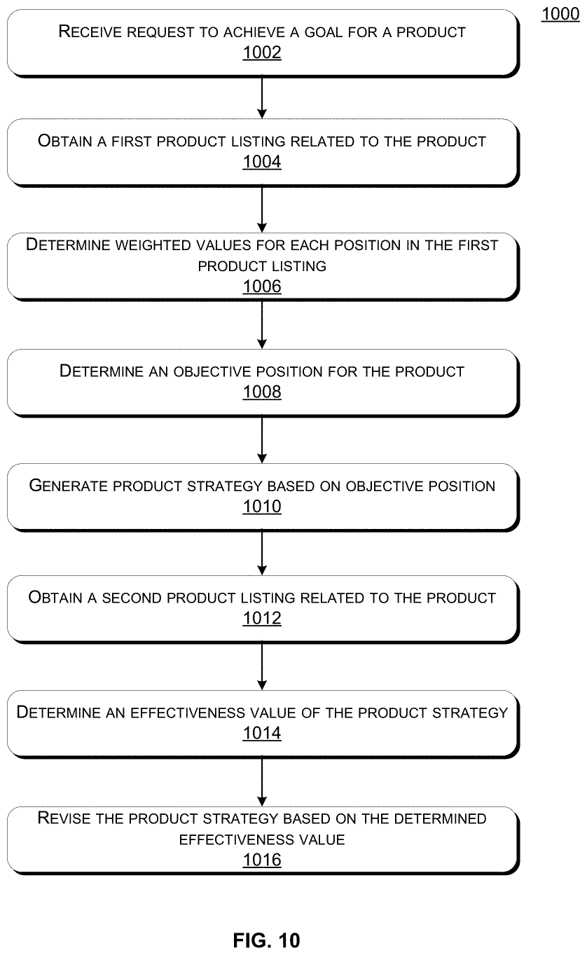

FIG. 10 depicts a flow diagram showing an example process flow 1000 for implementing and adjusting a product strategy in accordance with embodiments. The process 1000 may be performed by a computing device that is configured to generate and provide a product strategy for a product. For example, the process 1000 may be performed by a service provider computing device, such as the service provider 102 described with respect to FIG. 1 above.

At 1002, the process 1000 comprises receiving product data in relation to a request to achieve a goal for a product. In some embodiments, the goal comprises a target category share to be achieved for the product. In some embodiments, the product strategy for the product and the product data are received via a website operated by the computing device. As noted elsewhere, the product data may comprise one or more of a product image, a product name, a price, a product description, or a hidden data field.

At 1004, the process 1000 comprises obtaining a first product listing related to the product. In some embodiments, the first product listing is generated by an electronic retailer in response to receiving a search query related to the product using the set of search terms determined to be associated with the product. A product listing may comprise an ordered list of product face outs, each of the product face outs associated with a respective product. In some embodiments, the product face outs in the product listing are ordered based on a determined relevancy of each product face out to the set of search terms.

At 1006, the process 1000 comprises determining a weighted value for each position within the product listing. In some embodiments, the weighted value is determined as being representative of a category share for a product in each corresponding position within the product listing.

At 1008, the process 1000 comprises determining an objective position within the first product listing based at least in part on the goal. In some embodiments, the objective position within the first product listing is determined based on the weighted values and the goal. For example, if the goal is a certain percentage of category share, then the objective position may be one for which the associated weighted value is above or equal to that percentage.

At 1010, the process 1000 comprises generating a product strategy based on the objective position for the product. In some embodiments, the product strategy comprises revisions to the product data as well as a marketing strategy generated for the product. Additionally, the product strategy may further comprise an estimated expenditure associated with the marketing strategy.

At 1012, the process 1000 comprises, upon determining that the product strategy has been implemented, obtaining a second product listing related to the product. The product strategy is implemented by a seller providing the product data to an electronic retailer. The second product listing, like the first product listing, may be generated by an electronic retailer in response to receiving a search query related to the product using the set of search terms determined to be associated with the product. Note that the first product listing and the second product listing may be associated with a user segment defined by a set of search terms, such that products listed in the product listing pertain only to that user segment.

At 1014, the process 1000 comprises determining an effectiveness value of the product strategy based upon a difference between a first position of the product within the first product listing and a second position of the product within the second product listing. In some embodiments, the determined effectiveness value comprises a percentage that is representative of a degree to which the goal for the product has been achieved. For example, the service provider may predict that the implementation of a product strategy will result in a face out for the product being moved from a tenth position to a second position within a product listing. However, upon conducting a search after the product strategy has been implemented, the service provider may determine that the face out for the product is now in the fifth position instead of being in the second position. In this example, the process may determine that the product strategy resulted in an improvement of five positions rather than an improvement of eight positions as was predicted. Accordingly, the service provider may assign an effectiveness value of ⅝ or 62.5%. The service provider may then account for this effectiveness value when revising the product strategy. For example, the service provider may determine that any revisions will only have 62.5% of the impact on positioning that would be otherwise predicted.

At 1016, the process 1000 comprises revising the product strategy based on the determined effectiveness value. In some embodiments, revising the product strategy comprises adjusting an estimated expenditure for the marketing strategy. For example, if the initial marketing strategy recommends an expenditure directed toward certain search terms, then the revised product strategy may include additional expenditure directed toward additional search terms. By way of illustration, if the initial marketing strategy recommended an expenditure for a highest-frequency search term and a second-highest frequency search term, then the revised marketing strategy may include additionally recommend an expenditure for a third-highest frequency search term.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving, by a service provider, product data in relation to a request to achieve a goal for a product;
obtaining, by the service provider, a first product listing related to the product;
determining, by the service provider, an objective position within the first product listing based at least in part on the goal;
generating, by the service provider, a product strategy based on the objective position for the product;
upon determining that the product strategy has been implemented, obtaining, by the service provider, a second product listing related to the product;
determining, by the service provider, an effectiveness value of the product strategy based upon a difference between a first position of the product within the first product listing and a second position of the product within the second product listing; and
revising, by the service provider, the product strategy based on the determined effectiveness value.

2. The method of claim 1, wherein the goal comprises a target category share to be achieved for the product.

3. The method of claim 1, wherein the first product listing is generated by an electronic retailer in response to receiving a search query related to the product.

4. The method of claim 1, further comprising determining, by the service provider, a weighted value for each position within the first product listing, wherein the objective position within the first product listing is determined based on the weighted values and the goal.

5. The method of claim 4, wherein the weighted value is determined based at least on a category share for a product in each corresponding position within the product listing.

6. The method of claim 1, wherein the product strategy comprises revisions to the product data as well as a marketing strategy generated for the product

7. The method of claim 6, wherein the product strategy further comprises an estimated expenditure associated with the marketing strategy.

8. The method of claim 7, wherein revising the product strategy comprises adjusting the estimated expenditure for the marketing strategy.

9. The method of claim 1, wherein the request to generate the product strategy for the product and the product data are received via a website operated by the computing device.

10. A computing device comprising:
a processor; and
a memory including instructions that, when executed with the processor, cause the computing device to, at least:
receive product data in relation to a request to achieve a goal for a product;
obtain a first product listing related to the product;
determine an objective position within the first product listing based at least in part on the goal;
generate a product strategy based on the objective position for the product;
upon determining that the product strategy has been implemented, obtain a second product listing related to the product;
determine an effectiveness value of the product strategy based upon a difference between a first position of the product within the first product listing and a second position of the product within the second product listing; and
revise the product strategy based on the determined effectiveness value.

11. The computing device of claim 10, wherein the instructions further cause the computing device to determine a set of search terms to be associated with the product, wherein the product strategy is generated based on the set of search terms.

12. The computing device of claim 11, wherein the first product listing related to the product is obtained by the computing device upon conducting a search on an online marketplace using the set of search terms.

13. The computing device of claim 12, wherein the product listing comprises an ordered listing of product face outs, each of the product face outs associated with a respective product.

14. The computing device of claim 13, wherein the product face outs in the product listing are ordered based on a determined relevancy of each product face out to the set of search terms.

15. The computing device of claim 10, wherein the product data comprises one or more of a product image, a product name, a price, a product description, or a hidden data field.

16. The computing device of claim 15, wherein the product strategy comprises revisions to at least one of the product description or the hidden data field of the product data.

17. The computing device of claim 10, wherein the determined effectiveness value comprises a percentage representative of a degree to which the goal for the product has been achieved.

18. A non-transitory computer-readable media collectively storing computer-executable instructions that upon execution cause one or more computing devices to collectively perform acts comprising:
receiving product data in relation to a request to achieve a goal for a product;
obtaining a first product listing related to the product;
determining an objective position within the first product listing based at least in part on the goal;
generating a product strategy based on the objective position for the product;
upon determining that the product strategy has been implemented, obtaining a second product listing related to the product;
determining an effectiveness value for the product strategy based upon a difference between a first position of the product within the first product listing and a second position of the product within the second product listing; and
revising the product strategy based on the determined effectiveness value.

19. The non-transitory computer-readable media of claim 18, wherein the product strategy is implemented by a seller providing the product data to an electronic retailer.

20. The non-transitory computer-readable media of claim 18, wherein the first product listing and the second product listing are associated with a user segment defined by a set of search terms.
